(19) United States
(12) Patent Application Publication
(10) Pub. No.: US 2015/0046419 A1
(43) Pub. Date: Feb. 12, 2015

(54) METHOD OF SORTING SEARCH RESULTS BY RECOMMENDATION ENGINE

(71) Applicant: VIDMIND LTD., Tel-Aviv (IL)

(72) Inventors: Alex TENENBAUM, Shoham (IL); Ofer Herman, Ein-Sarid (IL)

(73) Assignee: VIDMIND LTD., Tel-Aviv (IL)

(21) Appl. No.: 13/964,142

(22) Filed: Aug. 12, 2013

(51) Int. Cl. G06F 17/30

(52) U.S. Cl. CPC G06F 17/30867
USPC 707/706; 707/732

(57) ABSTRACT

A method of sorting search results by recommendation engine is provided herein. The method starts off with receiving a search query from a user associated with a specific user ID. The method goes on to applying the search query to a search engine and to a content database, to yield search results. The method then goes on to retrieving a profile of the specific user from a preferences and history database, based on the user ID. Then the method proceeds to reordering the search results by a recommendation engine, based on the retrieved profile. Finally, the method concludes with providing the user with the reordered search results such that the order matches the profile of the user.

### BACKGROUND OF THE INVENTION

1. Technical Field

The present invention relates to content mining and more specifically to search engines.

2. Discussion of the Related Art

Whenever a user or a subscriber of a content database of any type searches for content, he or she sends a query to a search engine which returns a set of search results. However, different users may enter a similar or even an identical query while they are actually looking for different content. This may be the case as each of the users or subscribers have a different profile of content preferences. What the users actually are looking for is a subset of search results taken from the entire set of search results that is relevant to the search query that was entered.

The challenge is to provide the most relevant search results high in the order of the list of search results presented to the subscriber for each specific subscriber. Search systems today sort their results based on general information which is constant for all users that use the search engine. For example, Google™ search results are returned based on popularity of specific Web Site. This popularity is calculated universally and has no relation to subscriber's personal view.

Consequently, the subscriber is required to redefine the search query string according to the information he or she really wants to find and to add his preferences in to this query. This iterative search process is sometimes burdensome and ineffective and above all, depends on the ability of the user to cope with such an iterative search process which includes ongoing updating of search queries.

It would, therefore, be advantageous to provide a platform that is capable of both providing search results but also applying the specific user preferences or profile so that the search results presented to the user would be more customized in view of the user's profile.

### SUMMARY OF THE INVENTION

One embodiment of the invention provides a method of sorting search results by recommendation engine. The method starts off with receiving a search query from a user associated with a specific user ID. The method goes on to applying the search query to a search engine and to a content database, to yield search results. The method then goes on to retrieving a profile of the specific user from a preferences and history database, based on the user ID. Then, the method proceeds to reordering the search results by a recommendation engine, based on the retrieved profile. Finally, the method concludes with providing the user with the reordered search results such that the order matches the profile of the user.

Other embodiments of the invention may include a system arranged to execute the aforementioned method and a computer readable program configured to execute the aforementioned method. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating the system according to some embodiments of the invention; and

FIG. 2 is a high level flowchart illustrating an aspect according to some embodiments of the invention.

The drawings together with the following detailed description make apparent to those skilled in the art how the invention may be embodied in practice.

### DETAILED DESCRIPTION OF THE INVENTION

Prior to the detailed description being set forth, it may be helpful to set forth definitions of certain terms that will be used hereinafter.

The term “search engine” as used herein refers to an information retrieval system designed to help find information stored on a computer system. The search results are usually presented in a list and are commonly called hits. Search engines help to minimize the time required to find information and the amount of information which must be consulted, akin to other techniques for managing information overload.

The term “recommendation engine” as used herein refers to an information filtering system that seek to predict the ‘rating’ or ‘preference’ that a user would give to a content item (such as music, books, or movies) or social element (e.g., people or groups) they had not yet considered, using a model built from the characteristics of an item (content-based approaches) or the user's social environment (collaborative filtering approaches). Most common Recommendation Engine usages today: would provide a user, responsive to entering a query by the user, with a statement such as “People that liked this also like a, b, or, c” or “Recommended items for you are a, b, or, c”. It should be noted that these recommendations are driven from the query and not from the user.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

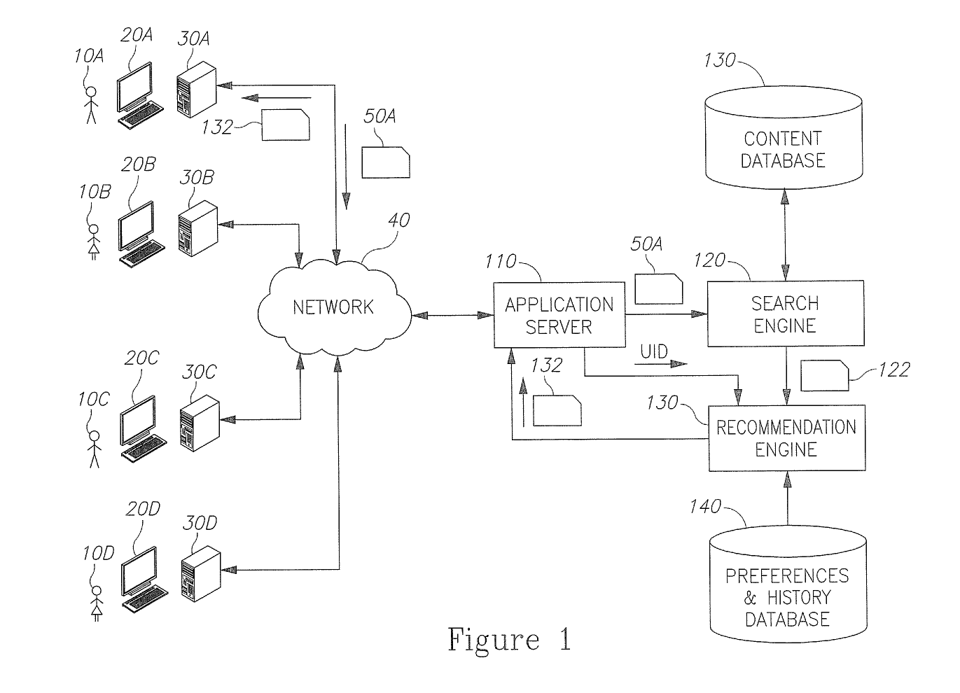

FIG. 1 is a high level schematic block diagram illustrating an environment of a system according to some embodiments of the invention. A plurality of users/subscribers 10A-10D are logged to a networked 40 via a plurality of client computers 30A-30D, each associated with a respective display 20A-20D. An application server 110 is accessible by any of client computers 30A-30D, via network 40. Application server 110 is in operative association with a search engine 120 which is in turn in communication with a content database 125. Application server 110 is further in operative association with a recommendation engine 130 which in further in communication with a preferences and history database 140 and further with search engine 120.

In operation, a user/subscriber 10A may enter a search query 50A via his client computer 30A. Search query 50A is transferred via network 40 to application server 110 which, in turn, transfers it to search engine 120 which then applies search query 50A to content database 125 for retrieving a list of search results 122. Then, recommendation engine 130 receives list of search results 122. Recommendation engine 130 receives from application server 110, for each list of search results 122 associated with search query 50A, the user identification (UID) associated with search query 50A. Recommendation engine 130 then retrieves from preferences & history database 140 the profile of user/subscriber 10A based on its UID. The retrieved profile is used by recommendation engine 130 to reorder list of search results 122 so that the ordered list of search results 132 matches the profile of user/subscriber 10A. Ordered list of search results 132 is then conveyed by application server 110 to the respective computer client 30A and presented over display 20A to user/subscriber 10A.

A possible implementation of the aforementioned architecture may, by way of example only, operate with SOLR™ as a search engine 120 and with Mahout™ as a recommendation engine. It is understood that other implementation may be used by a person having ordinary skills in the art.

According to some embodiments of the invention, two types of search queries 50A can be sent to search engines 120. One type is editors-defined “Dynamic catalogs”. Those are predefined searches that were defined by content editors. The second type is “Free search” where query strings that were entered by end users directly. Application server 110 supports both types.

According to some embodiments of the invention, ordered list 132 is capped at top N results having a relevancy above a predefined threshold that may me so designed than N=M, with M being a number such as 100 that is considered manageable for content browsing by users/subscribers 10A-10D.

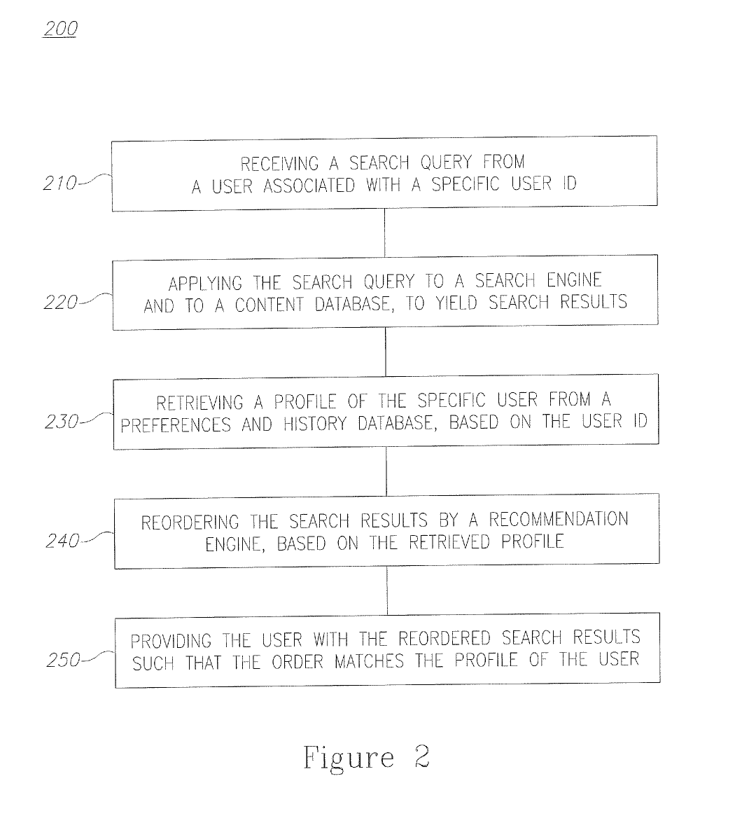

FIG. 2 is a high level flowchart illustrating an aspect according to some embodiments of the invention. Method 200 may be implemented by any architecture and should not be regarded as limited to the aforementioned architecture of system 1100. Method 200 includes the following stages: receiving a search query from a user associated with a specific user ID 210; applying the search query to a search engine and to a content database, to yield search results 220; retrieving a profile of the specific user from a preferences and history database, based on the user ID 230; reordering the search results by a recommendation engine, based on the retrieved profile 240; and providing the user with the reordered search results such that the order matches the profile of the user 250.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of sorting search results by recommendation engine executed by a computer processor, the method comprising:
receiving a search query from a user associated with a specific user ID;
applying the search query to a search engine and to a content database, to yield search results;
retrieving a profile of the specific user from a preferences and history database, based on the user ID;
reordering the search results by a recommendation engine, based on the retrieved profile; and
providing the user with the reordered search results such that the order matches the profile of the user.

2. The method according to claim 1, wherein the application server is further configured to provide the user with the reordered search results such that the order matches the profile of the user.

3. The method according to claim 1, wherein the user profile database associated a user ID with its profile of history content usage and preferences.

4. The method according to claim 1, wherein the application server extracts from a search query from each one of the users, its respective user ID and forwards it to the recommendation engine which applied it to the user profiles database.

5. The method according to claim 1, wherein the user provides the user ID explicitly.

6. The method according to claim 1, wherein the recommendation engine applies a weighting scheme based on the user profile associated with a specific user ID, to the list of search results, to extract a subset of search results, based on the weighting scheme.

7. The method according to claim 1, wherein the recommendation engine is configured to apply a cost function for maximizing values of subset of search results.

8. The method according to claim 1, wherein the ordered list of search results is capped at N search results having a relevancy score above a predefined threshold.

9. A system for sorting search results by a recommendation engine, the system comprising:
an application server executed by a computer processor, configured to receive a search query from a user associated with a specific user ID;
a search engine configured to applying the search query to a content database, to yield search results;
a user profile database configured to retrieve a profile of the specific user from a preferences and history database, based on the user ID; and
a recommendation engine configured to reorder the search results by, based on the retrieved profile.

10. The system according to claim 9, wherein the application server is further configured to provide the user with the reordered search results such that the order matches the profile of the user.

11. The system according to claim 9, wherein the user profile database associated a user ID with its profile of history content usage and preferences.

12. The system according to claim 9, wherein the application server extracts from a search query from each one of the users, its respective user ID and forwards it to the recommendation engine which applied it to the user profiles database.

13. The system according to claim 9, wherein the user provides the user ID explicitly.

14. The system according to claim 9, wherein the recommendation engine applies a weighting scheme based on the user profile associated with a specific user ID, to the list of search results, to extract a subset of search results, based on the weighting scheme.

15. The system according to claim 9, wherein the recommendation engine is configured to apply a cost function for maximizing values of subset of search results.

16. The system according to claim 9, wherein the ordered list of search results is capped at N search results having a relevancy score above a predefined threshold.

17. A computer program product for sorting search results by a recommendation engine, the computer program product comprising:
a computer readable storage medium having computer readable program embodied therewith, the computer readable program comprising:
computer readable program configured to receive a search query from a user associated with a specific user ID;
computer readable program configured to apply the search query to a content database, to yield search results;
computer readable program configured to configured to retrieve a profile of the specific user from a preferences and history database, based on the user ID; and
computer readable program configured to reorder the search results by, based on the retrieved profile.

18. The computer program product according to claim 17, wherein the user profile associates a user ID with its profile of history content usage and preferences.

19. The computer program product according to claim 17, wherein the user provides the user ID explicitly.

20. The computer program product according to claim 17, further comprising a computer readable code configured to apply a weighting scheme based on the user profile associated with a specific user ID, to the list of search results, to extract a subset of search results, based on the weighting scheme.
